(19) United States
(12) Patent Application Publication
(10) Pub. No.: US 2026/0253045 A1
(43) Pub. Date: Aug. 27, 2026

(54) REPAIR MANAGEMENT SYSTEM, REPAIR MANAGEMENT METHOD AND NON-TRANSIENT COMPUTER-READABLE STORAGE MEDIUM

(71) Applicant: LITE-ON TECHNOLOGY CORPORATION, TAIPEI CITY (TW)

(72) Inventor: Shau-Shiuan Hung, TAIPEI CITY (TW)

(21) Appl. No.: 19/388,958

(22) Filed: Nov. 13, 2025

Related U.S. Application Data
(60) Provisional application No. 63/763,322, filed on Feb. 26, 2025.

(30) Foreign Application Priority Data
Sep. 22, 2025 (CN) 202511352887.5

(51) Int. Cl. G06Q 10/20

(52) U.S. Cl. CPC G06Q 10/20

(57) ABSTRACT

A repair management system, a repair management method and a non-transient computer-readable storage medium. The repair management system includes a processing device. The processing device receives pieces of repair center information from a plurality of repair centers and obtains repair request information. The processing device is configured to access the plurality of repair center hosts to perform: calculating a repair center characteristic index set of each of the repair centers according to the pieces of repair center information and the repair request information; calculating a comprehensive weight index of each of the repair centers according to the repair center characteristic index set of each of the repair centers; and labelling the repair center corresponding to a largest one among the comprehensive weight indexes as a primary delivery location.

### CROSS-REFERENCE TO RELATED PATENT APPLICATION

This application claims the benefit of priorities to the U.S. Provisional Patent Application Ser. No. 63/763,322, filed on Feb. 26, 2025, and China Patent Application Ser. No. 202511352887.5, filed on Sep. 22, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a logistics management method and a device for executing the logistics management method, especially for a repair management system, a repair management method, and a non-transient computer-readable storage medium.

### BACKGROUND OF THE DISCLOSURE

In the field of repair and delivery, the efficient use of repair resources has always been a difficult task. When customer services representatives receive a repair request from a customer, they analyze the supplier of the product in the repair request and deliver the product to the designated repair center.

For example, products from a first supplier are delivered to a first repair center, and products from a second supplier are delivered to a second repair center.

However, this repair dispatch method does not consider a current workload of a designated repair center. This can lead to the designated repair center being overloaded while other unassigned repair centers remain idle. Due to the uneven workload across repair centers, repair resources are not used efficiently.

### SUMMARY OF THE DISCLOSURE

The present disclosure provides a repair management system, a repair management method, and a non-transient computer-readable storage medium that are mainly used to address the issue of inefficient use of repair resources.

In order to solve the above-mentioned problems, one of the technical aspects adopted by the present disclosure is to provide a repair management system. The repair management system is communicatively connected to a plurality of repair center hosts, the plurality of repair center hosts are located in a plurality of repair centers, respectively. The repair management system includes a processing device and a storage device. The processing device receives pieces of repair center information from the plurality of repair centers. The storage device is electrically connected to the processing device and stores repair request information. The processing device is configured to access the plurality of repair center hosts to perform: calculating a repair center characteristic index set of each of the repair centers according to the pieces of repair center information and the repair request information; calculating a comprehensive weight index of each of the repair centers according to the repair center characteristic index set of each of the repair centers; and labelling the repair center corresponding to a largest one among the comprehensive weight indexes as a primary delivery location.

In order to solve the above-mentioned problems, another one of the technical aspects adopted by the present disclosure is to provide a repair management method that includes: reading, by a processing device, repair request information of a storage device and pieces of repair center information of a plurality of repair centers; calculating, by the processing device, a repair center characteristic index set of each of the repair centers according to the pieces of repair center information and the repair request information; calculating, by the processing device, a comprehensive weight index of each of the repair centers according to the repair center characteristic index set of each of the repair centers; and labelling, by the processing device, the repair center corresponding to a largest one among the comprehensive weight indexes as a primary delivery location.

In order to solve the above-mentioned problems, yet another one of the technical aspects adopted by the present disclosure is to provide a non-transitory computer-readable storage medium. The non-transitory computer-readable storage medium stores a plurality of instructions, and the plurality of instructions are executed by a processing device to generate the repair management method.

In summary, the repair management system, the repair management method, and the non-transitory computer-readable storage medium select an appropriate repair center as a primary delivery location according to the comprehensive weight index of each of the repair centers, thereby preventing repair centers from being overloaded or idle. The repair center information stored in each of the repair center hosts is appropriately utilized to improve repair service quality, repair service efficiency, and scheduling flexibility of each of the repair centers.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a repair management system according to one embodiment of the present disclosure.

FIG. 2 is a flow chart of a repair management method according to a first embodiment of the present disclosure.

FIG. 3 is a flow chart of a calculation method of a load index of a repair center according to one embodiment of the present disclosure.

FIG. 4 is a flow chart of a calculation method of a demand type index of a repair center according to one embodiment of the present disclosure.

FIG. 5 is a flow chart of a calculation method of a geographical location index of a repair center according to one embodiment of the present disclosure.

FIG. 6 is a flow chart of a calculation method of a priority index of a repair center according to one embodiment of the present disclosure.

FIG. 7 is a flow chart of a calculation method of a customer preference index of a repair center according to one embodiment of the present disclosure.

FIGS. 8A-8B is a flow chart of a repair management method according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

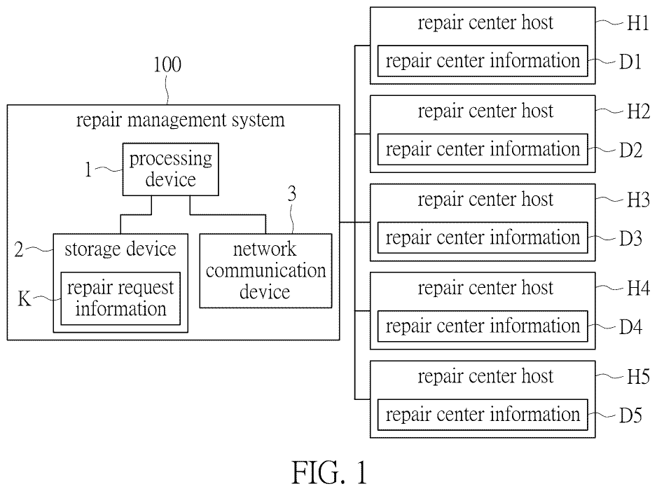

FIG. 1 is a schematic diagram of a repair management system according to one embodiment of the present disclosure. Referring to FIG. 1, the repair management system 100 includes a processing device 1, a storage device 2, and a network communication device 3.

The processing device 1 is, for example, a central processing unit (CPU), a programmable logic controller circuit (PLC), a micro-processor circuit (MCU), or a micro-control circuit (MCC).

The storage device 2 is, for example, a storage medium such as a hard disk drive (HDD) or a solid-state drive (SSD), but is not limited thereto.

The processing device 1 is electrically connected to the storage device 2 and the network communication device 3. The processing device 1 receives repair request information K from a user device and stores the repair request information K in the storage device 2.

The repair management system 100 establishes communication connections (i.e., network connections) with a repair center host H1 of a first repair center, a repair center host H2 of a second repair center, a repair center host H3 of a third repair center, a repair center host H4 of a fourth repair center, and a repair center host H5 of a fifth repair center through the network communication device 3.

The processing device 1 respectively receives pieces of repair center information D1 to D5 from the repair center hosts H1 to H5 and stores the pieces of repair center information D1 to D5 in storage device 2. In one embodiment, each of the pieces of repair center information D1 to D5 includes the quantity of tasks, the maximum quantity of tasks, the processing time, and the maximum processing time. Furthermore, each of the pieces of repair center information D1 to D5 also includes a fault type that the repair center can handle, the technical difficulty of a repair task, the quantity of brands the repair center can handle, the repair center location, a list of partner manufacturers, a repair equipment type, a repair center expertise, and a customer satisfaction rating.

The processing device 1 is configured to calculate a repair center characteristic index set of each of the repair centers according to the pieces of repair center information D1 to D5 and the repair request information K.

The processing device 1 is configured to calculate a comprehensive weight index of each of the repair centers according to the repair center characteristic index set of each of the repair centers, in which the repair center characteristic index set of each of the repair centers includes a load index, a demand type index, a geographical location index, a priority index, and a customer preference index.

The processing device 1 is configured to determine a largest one among the comprehensive weight indexes, and labels the repair center corresponding to the largest one among the comprehensive weight indexes as a primary delivery location.

The processing device 1 transmits a delivery result to a user device via the network communication device 3.

After the processing device 1 assigns all of repair tasks of the repair request information K to the primary delivery location, the processing device 1 recalculates an updated load index of the primary delivery location.

Specifically, after the repair center at the primary delivery location accepts all of the repair tasks of the repair request information K, the load index of the primary delivery location is increased.

The storage device 2 presets a load index threshold of each of the repair centers, and the processing device 1 is configured to determine whether the updated load index of the repair center that has been used as the primary delivery location is greater than the load index threshold.

When the updated load index of the primary delivery location is greater than the load index threshold, the processing device 1 is configured to label one of the other repair centers that is not labeled as the primary delivery location as a secondary delivery location.

The processing device 1 transmits an updated delivery result to a user device via the network communication device 3.

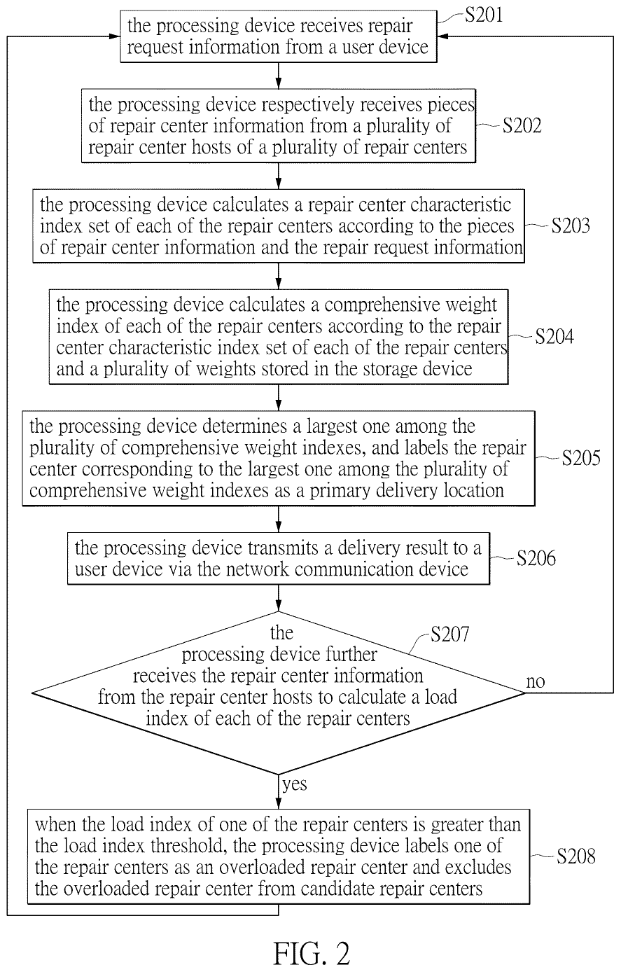

FIG. 2 is a flow chart of a repair management method according to a first embodiment of the present disclosure. The storage device 2 stores a plurality of instructions, and the processing device 1 executes the plurality of instructions to generate the repair management method shown in FIG. 2.

Specifically, the storage device 2 stores a comprehensive weight index formula, and the comprehensive weight index formula is: W=argmax(−α₁×L+α₂×C+α₃×T+α₄×R+α₅×P).

W=comprehensive weight index; L=load index; C=demand type index; T=geographical location index; R=priority index; P=customer preference index; α₁=load weight; α₂=demand type weight; α₃=geographical location weight; α₄=priority weight; α₅=customer preference weight. For example, α₁=0.3, α₂=0.25, α₃=0.2, α₄=0.15, and α₅=0.1.

In one embodiment, a task diversity weight, a technical complexity weight, and a brand diversity weight are stored in the storage device 2, the task diversity weight, the technical complexity weight, and the brand diversity weight can be set according to user's needs and are not limited thereto.

Each of α₁ [symbol] α₂ [symbol] α₃ [symbol] α₄ [symbol] α₅ is larger than 0 and smaller than 1, and α₁+α₂+α₃+α₄+α₅=1.

Referring to FIG. 2, in step S201, the processing device 1 receives repair request information K from a user device. In one embodiment, repair request information K includes a supplier, a product name, a fault description, a customer location, a warranty status, a customer level, a customer preference, and a batch requirement. Furthermore, the repair request information K includes a plurality of fault percentages and a list of partner manufacturers.

For example, Company A is a supplier, the product name is a laptop with a model number of Pro-X, and the fault description describes multiple faults. In detail, the fault description includes a fault problem of each product. For example, multiple faults include a displayer fault and an operating system crash; the customer location is actual address information or coordinate information; the warranty status is that the product is under warranty; the customer level is a corporate very important person (VIP) customer. In detail, a plurality of customer levels respectively indicates different levels of customers, and the processing order is arranged according to the different levels of the customers. For example, the different customer levels from low to high include a general customer, a corporate customer, a VIP customer, and a corporate VIP customer. The customer preference is to give a priority to a repair center with a shortest distance between the repair center and the customer and a fast-processing speed. For example, the shortest distance is less than 50 kilometers, and the fast-processing speed is less than 48 hours/unit; the batch requirement is that 10 devices need to be processed at the same time.

In step S202, the processing device 1 respectively receives pieces of repair center information D1 to D5 from a plurality of repair center hosts H1 to H5 of a plurality of repair centers, in which the plurality of repair center hosts H1 to H5 are located in the plurality of repair centers established in different regions or the same region.

In step S203, the processing device 1 calculates a repair center characteristic index set of each of the repair centers according to the pieces of repair center information D1 to D5 and the repair request information K. Each of the repair center characteristic index sets includes a load index, a demand type index, a geographical location index, a priority index, and a customer preference index.

In step S204, the processing device 1 calculates a comprehensive weight index of each of the repair centers according to the repair center characteristic index set of each of the repair centers and a plurality of weights stored in the storage device 2, in which the plurality of weights include a load weight, a demand type weight, a geographical location weight, a priority weight and a customer preference weight.

In step S205, the processing device 1 determines a largest one among the plurality of comprehensive weight indexes, and labels the repair center corresponding to the largest one among the plurality of comprehensive weight indexes as a primary delivery location.

In step S206, the processing device 1 transmits a delivery result to a user device via the network communication device 3.

For example, the processing device 1 calculates five comprehensive weight indexes of the first repair center 1 to the fifth repair center 5 as 0.403, 0.453, 0.143, 0.260, and 0.336, respectively. The processing device 1 determines that the second repair center 2 has a largest comprehensive weight index and therefore designates the second repair center 2 as a primary delivery location. In other words, the processing device 1 assigns all of repair tasks of the repair request information K to the second repair center 2. Finally, the processing device 1 transmits information indicating that the second repair center 2 is a delivery location (i.e., a delivery result) to a user device via the network communication device 3.

In step S207, the processing device 1 further receives the repair center information D1 to D5 from the repair center hosts H1 to H5 to calculate (or update) a load index of each of the repair centers. The processing device 1 also monitors whether the load index of each of the repair centers is greater than a load index threshold. If yes, repair management method goes to step S208. Conversely, if not, a current load distribution strategy is maintained, and the repair management method returns to step S201.

In step S208, when the load index of one of the repair centers is greater than the load index threshold, the processing device 1 labels one of the repair centers as an overloaded repair center and excludes the overloaded repair center from candidate repair centers, and then the repair management method returns to step S201.

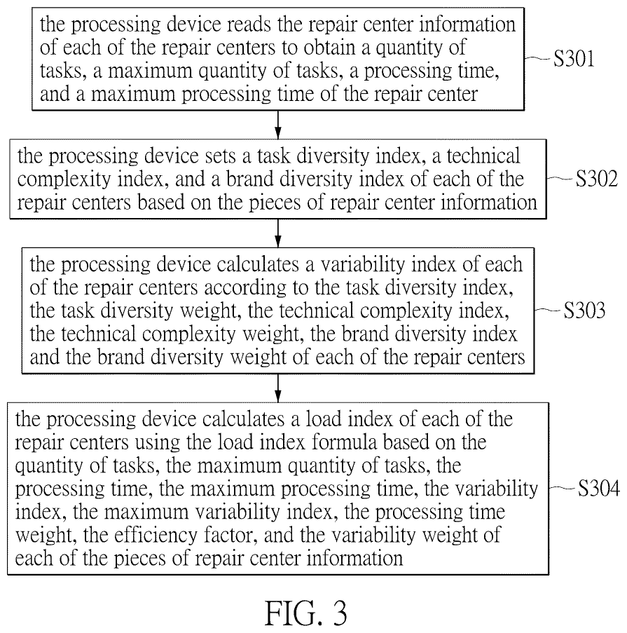

FIG. 3 is a flow chart of a calculation method of a load index of a repair center according to one embodiment of the present disclosure.

In one embodiment, the storage device 2 stores a load index formula, and the load index formula is: L=(Nc/Nmax)+β(Tc/Tmax)×(1−E)+γ (V/Vmax).
L=load index.
Nc=quantity of tasks, which is the quantity of repair tasks that have been accepted by each repair center.
Nmax=maximum quantity of tasks, which is the maximum quantity of tasks that the repair center can handle.
Tc=processing time, which is the time it takes for a repair center to complete all accepted repair tasks.
Tmax=maximum processing time, which is a maximum available working time in a repair center during a workday.
V=variability index, which represents a current multi-fault variability and reflects an overall complexity of all tasks currently handled by the repair center. This is primarily influenced by factors such as the diversity of task types, technical complexity, and the diversity of repair brands. In other words, a higher variability index indicates a higher complexity of tasks that the repair center can handle. For example, the variability index ranges from 0 to 1.
Vmax=maximum variability index, which is, for example, 1.
β=processing time weight, which is, for example, between 0 and 1.
E=efficiency factor. A higher efficiency factor indicates a more efficient repair center. For example, the efficiency factor ranges from 0 to 1.
γ=variability weight, which is, for example, between 0 and 1.

In this embodiment, the repair center information D1-D5 of each of the repair centers includes the quantity of tasks, the maximum quantity of tasks, the processing time, and the maximum processing time; the storage device 2 stores the variability index, the maximum variability index, the processing time weight, the efficiency factor, and the variability weight of each of the repair centers.

In step S301, the processing device 1 reads the repair center information D1 to D5 of each of the repair centers to obtain a quantity of tasks, a maximum quantity of tasks, a processing time, and a maximum processing time of the repair center.

The storage device 2 stores a variability index formula, and the variability index formula is: V=W_{d}×D+W_{C}×C+W_{B}×B.

The variability index ranges from 0 to 1, and a higher variability index indicates a higher complexity of the tasks that a repair center can handle.
W_{d}=task diversity weight, for example, W_{d}=0.4.
W_{C}=technical complexity weight, for example, W_{C}=0.3.
W_{B}=brand diversity weight, for example, W_{B}=0.3.

In one embodiment, the task diversity weight, the technical complexity weight, and the brand diversity weight are stored in the storage device 2 and can be set according to needs and are not limited thereto.

Each of W_{d}, W_{C}, and W_{B} is greater than 0 and less than 1, and W_{d}+W_{C}+W_{B}=1.
D=task diversity index. A higher task diversity index indicates a greater variety of fault types a repair center can handle.
C=technical complexity index. A higher technical complexity index indicates a higher technical difficulty level for the repair tasks a repair center can handle.
B=brand diversity index. A higher brand diversity index indicates a greater variety of brands a repair center can handle.

In step S302, the processing device 1 sets a task diversity index, a technical complexity index, and a brand diversity index of each of the repair centers based on the pieces of repair center information D1 to D5. In one embodiment, the processing device 1 sets the diversity index, the technical complexity index, and the brand diversity index of each of the repair centers according to fault types that the repair center can be handled, the technical difficulty of repair tasks of the repair center, and the quantity of brands that the repair center can handle of each of pieces of repair center information D1 to D5.

In step S303, the processing device 1 calculates a variability index of each of the repair centers according to the task diversity index, the task diversity weight, the technical complexity index, the technical complexity weight, the brand diversity index and the brand diversity weight of each of the repair centers.

For example, the processing device 1 reads the repair center information D1 from the first repair center and learns that the first repair center can repair eight different types of hardware devices. Therefore, the processing device 1 sets the task diversity index of the first repair center as 0.8. The processing device 1 reads the repair center information D2 and learns that the second repair center can repair six types different hardware devices. Therefore, the processing device 1 sets the task diversity index of the second repair center as 0.6. The processing device 1 reads the repair center information D3 and learns that the third repair center can repair one type of hardware device. Therefore, the processing device 1 sets the task diversity index of the third repair center as 0.1.

For example, the processing device 1 reads the repair center information D1 and learns that the first repair center can handle high-tech hardware and software issues. Therefore, the processing device 1 sets the technical complexity index of the first repair center as 0.8. The processing device 1 reads the repair center information D2 and learns that the second repair center can only handle medium-tech hardware and software issues. Therefore, the processing device 1 sets the technical complexity index of the second repair center as 0.4.

For example, the processing device 1 reads the repair center information D1 and learns that the first repair center primarily repairs products from five different brand suppliers. Therefore, the processing device 1 sets the brand diversity index of the first repair center as 0.5. Since the processing device 1 reads the repair center information D2 and learns that the second repair center only repairs products from a single brand supplier, the processing device 1 sets the brand diversity index of the second repair center as 0.1.

In step S304, the processing device 1 calculates a load index of each of the repair centers using the load index formula based on the quantity of tasks, the maximum quantity of tasks, the processing time, the maximum processing time, the variability index, the maximum variability index, the processing time weight, the efficiency factor, and the variability weight of each of the pieces of repair center information D1 to D5.

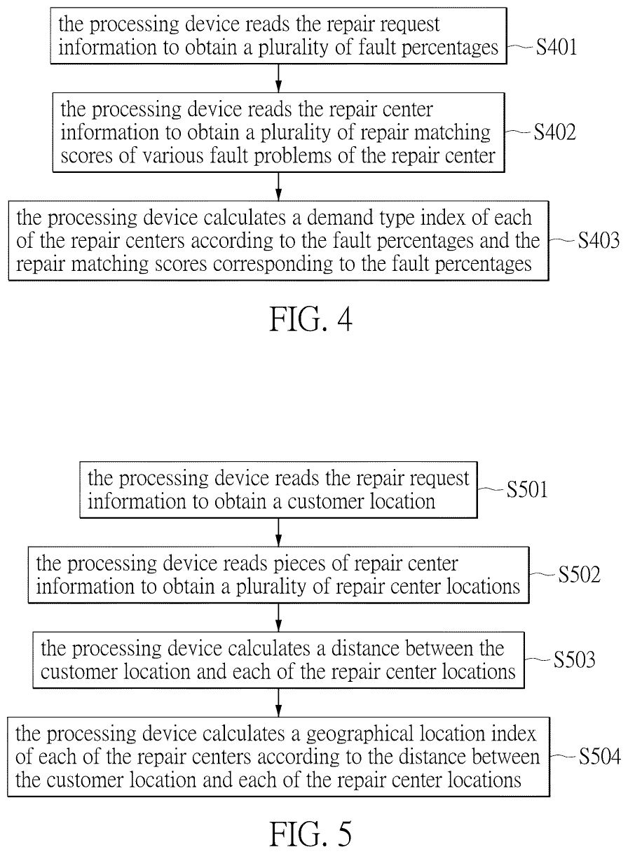

FIG. 4 is a flow chart of a calculation method of a demand type index of a repair center according to one embodiment of the present disclosure.

In step S401, the processing device 1 reads the repair request information K to obtain a plurality of fault percentages, in which the plurality of fault percentages represent ratios of various fault problems.

In step S402, the processing device 1 reads the repair center information to obtain a plurality of repair matching scores of various fault problems of the repair center.

In step S403, the processing device 1 calculates a demand type index of each of the repair centers according to the fault percentages and the repair matching scores corresponding to the fault percentages.

For example, the processing device 1 reads the repair request information K and determines that a fault percentage of a hardware fault problem and a fault percentage of a software fault problem of the repair request information K are 60% and 40%, respectively. The processing device 1 reads the repair center information D1 and determines that a repair matching score of the hardware fault problem of the first repair center and a repair matching score of the software fault problem of the first repair center are 0.83 and 1.0, respectively. The repair matching score can be set based on a handling capability of each of the repair centers for different fault problems, and are not limited thereto. For example, the first repair center can handle a display hardware fault problem, a battery hardware fault problem, and a system software fault problem, the repair matching score of the hardware fault problem of the first repair center and the repair matching score of the software fault problem of the first repair center are 0.83 and 1.0, respectively.

Finally, the processing device 1 calculates a demand type index C of the first repair center based on the fault percentages (the hardware fault percentage and the software fault percentage are 60% and 40% respectively) and the repair matching score (the hardware repair matching score and the software repair matching score are 0.83 and 1.0 respectively). The demand type index C=(0.6×0.83)+(0.4×1.0)=0.90.

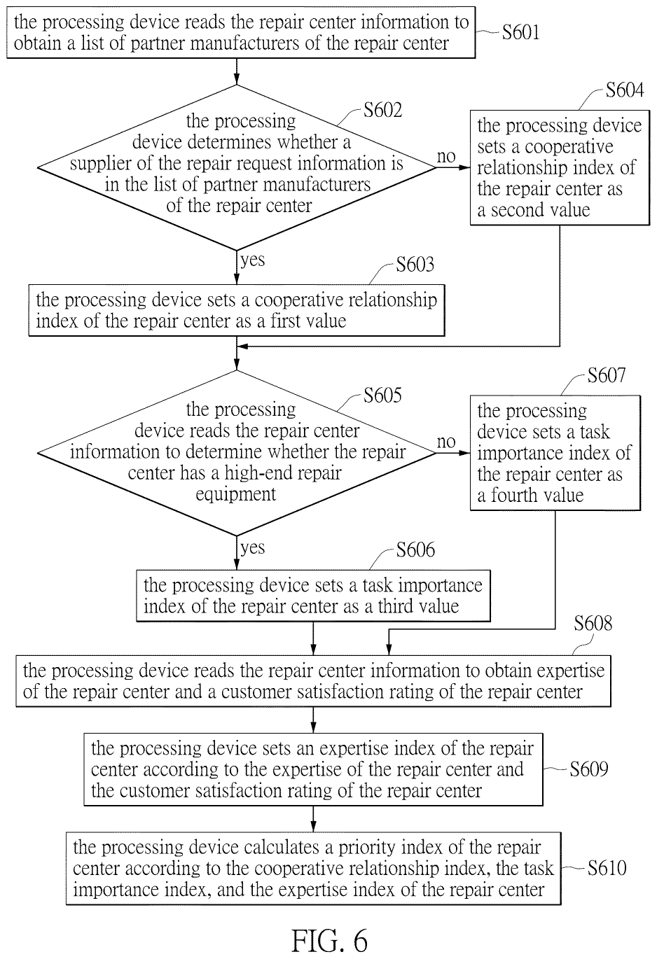

FIG. 5 is a flow chart of a calculation method of a geographical location index of a repair center according to one embodiment of the present disclosure.

The storage device 2 stores a geographical location index formula, and the geographical location index formula is:

$$T = 1 - ( \frac{D}{D max} ) .$$

D=a distance between a customer location and a repair center location.

In step S501, the processing device 1 reads the repair request information K to obtain a customer location.

In step S502, the processing device 1 reads pieces of repair center information to obtain a plurality of repair center locations.

In step S503, the processing device 1 calculates a distance between the customer location and each of the repair center locations.

Specifically, the customer location and the repair center locations can be actual addresses, the processing device 1 inputs the customer location and the repair center locations into a global positioning system (GPS) to obtain a customer coordinate and multiple repair center coordinates. The processing device 1 uses Haversine formula to calculate a shortest distance between the customer coordinate and one of the repair center coordinates, which serves as the distance between the customer location and the repair center location.

In step S504, the processing device 1 calculates a geographical location index of each of the repair centers according to the distance between the customer location and each of the repair center locations.

For example, a first distance D1 between the first repair center location and the customer location is 0 kilometers, a second distance D2 between the second repair center location and the customer location is 80 kilometers, a third distance D3 between the third repair center location and the customer location is 160 kilometers, a fourth distance D4 between the fourth repair center location and the customer location is 350 kilometers, and a fifth distance D5 between the fifth repair center location and the customer location is 30 kilometers, wherein the fourth distance D4 is a maximum distance (Dmax).

The processing device 1 calculates the geographical location index of each of the repair centers. For example, the geographical location index of the first repair center=1−(D1/Dmax)=1−(0/350)=1. The geographical location index of the second repair center=1−(D2/Dmax)=1−(80/350)=0.771. The geographical location index of the third repair center=1−(D3/Dmax)=1−(160/350)≅0.543. The geographical location index of the fourth repair center= 1−(D4/Dmax)=1−(350/350)=0. The geographical location index of the fifth repair center=1−(D5/Dmax)=1−(30/350)≅0.914. The first repair center has the highest geographical location index, indicating that the first repair center offers the best transportation conditions for the customer. The fourth repair center has the lowest geographical location index, indicating that the fourth repair center offers the worst transportation conditions for the customer.

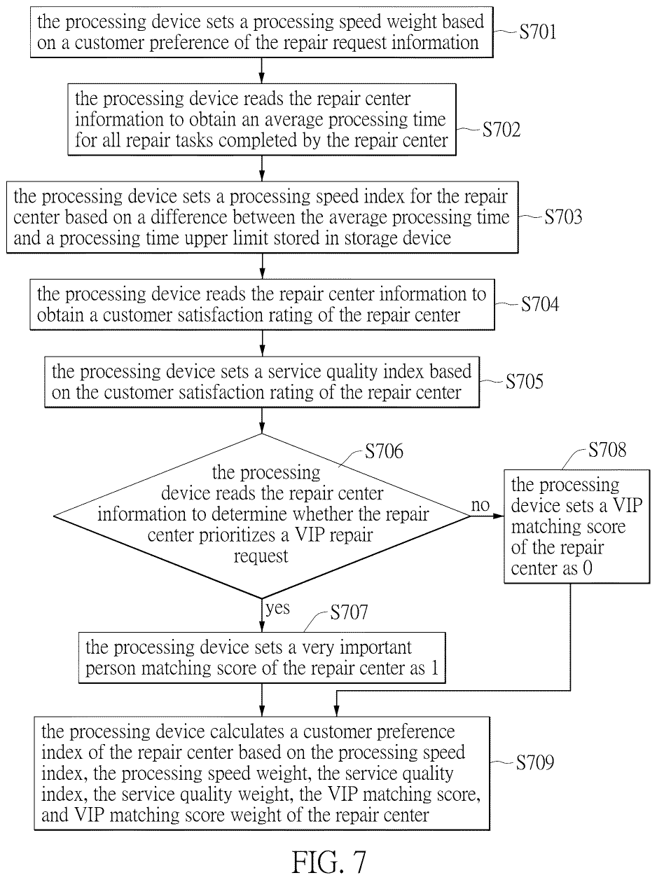

FIG. 6 is a flow chart of a calculation method of a priority index of a repair center according to one embodiment of the present disclosure.

The storage device 2 stores a priority index formula, and the priority index formula is: R=R1+R2+R3.

R=priority index, R1=cooperative relationship index, R2=task importance index, and R3=expertise index.

In step S601, the processing device 1 reads the repair center information to obtain a list of partner manufacturers of the repair center.

In step S602, the processing device 1 determines whether a supplier of the repair request information K is in the list of partner manufacturers of the repair center. If so, the calculation method goes to step S603. If not, the calculation method goes to step S604.

In step S603, the processing device 1 sets a cooperative relationship index of the repair center as a first value.

In step S604, the processing device 1 sets a cooperative relationship index of the repair center as a second value.

In one embodiment, the first value and the second value are greater than 0 and less than 1, and the first value is greater than the second value.

In step S605, the processing device 1 reads the repair center information to determine whether the repair center has a high-end repair equipment. If so, the calculation method goes to step S606. If not, the calculation method goes to step S607.

In step S606, the processing device 1 sets a task importance index of the repair center as a third value.

In step S607, the processing device 1 sets a task importance index of the repair center as a fourth value.

In one embodiment, the third value and the fourth value are greater than 0 and less than 1, and the third value is greater than the fourth value.

In step S608, the processing device 1 reads the repair center information to obtain expertise of the repair center and a customer satisfaction rating of the repair center.

In step S609, the processing device 1 sets an expertise index of the repair center according to the expertise of the repair center and the customer satisfaction rating of the repair center.

For example, when the expertise of the first repair center includes hardware repair and software repair, and the customer satisfaction rating of the first repair center is 85%, the processing device 1 sets the expertise index of the first repair center as 0.3. When the expertise of the second repair center only includes software repair, and the customer satisfaction rating of the second repair center is 70%, the processing device 1 sets the expertise index of the second repair center as 0.1.

In step S610, the processing device 1 calculates a priority index of the repair center according to the cooperative relationship index, the task importance index, and the expertise index of the repair center.

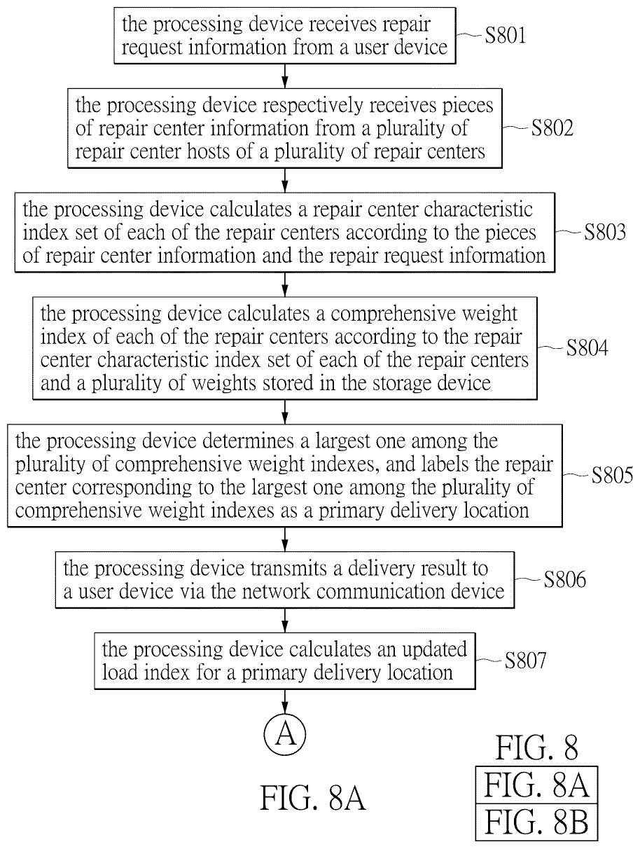

FIG. 7 is a flow chart of a calculation method of a customer preference index of a repair center according to one embodiment of the present disclosure.

The storage device 2 stores a customer preference index formula, and the customer preference index formula is: P=Wₛ×S+W_{Q}×Q+W_{V}×V_{match}.
P=customer preference index.
S=processing speed index.
Q=service quality Index.
V_{match}=very important person (VIP) matching score.
W_{S}=processing speed weight, for example, 0.5.
W_{Q}=service quality weight, for example, 0.3.
W_{V}=very important person (VIP) matching weight, for example, 0.2.

In one embodiment, the processing speed weight, the service quality weight, and VIP matching weight are stored in the storage device 2 and can be configured as needed and are not limited thereto. W_{S} [symbol] W_{Q} [symbol] W_{V} are greater than 0 and less than 1, and W_{S}+W_{Q}+W_{V}=1.

In step S701, the processing device 1 sets a processing speed weight based on a customer preference of the repair request information K.

For example, when the customer preference of the repair request information K is “the repair task can be completed before a date specified by the customer”, the processing device 1 sets a processing speed weight as 0.5.

When the customer preference of the repair request information K does not specify any specific requirements, the processing device 1 sets a processing speed weight as 0.3.

In step S702, the processing device 1 reads the repair center information to obtain an average processing time for all repair tasks completed by the repair center.

In step S703, the processing device 1 sets a processing speed index for the repair center based on a difference between the average processing time and a processing time upper limit stored in storage device 2.

For example, the processing device 1 reads the repair center information D1 and determines that an average processing time for the first repair center is 36 hours. The processing time upper limit stored in storage device 2 is 48 hours. Since the processing device 1 determines that the average processing time for the first repair center is less than the processing time upper limit, the processing device 1 sets a processing speed index for the first repair center as 0.9.

For example, the processing device 1 reads the repair center information D2 and determines that an average processing time for the second repair center is 50 hours. The processing time upper limit stored in storage device 2 is 48 hours. Since the processing device 1 determines that the average processing time for the second repair center is larger than the processing time upper limit, the processing device 1 sets a processing speed index for the second repair center as 0.5.

In step S704, the processing device 1 reads the repair center information to obtain a customer satisfaction rating of the repair center.

In step S705, the processing device 1 sets a service quality index based on the customer satisfaction rating of the repair center.

For example, the processing device 1 reads the repair center information D1 and learns that the customer satisfaction rating for the first repair center is 85%. Based on the customer satisfaction rating for the first repair center, the processing device 1 sets the service quality index for the first repair center to 0.85. The processing device 1 reads the repair center information D2 and learns that the customer satisfaction rating for the second repair center is 90%. Based on the customer satisfaction rating for the second repair center, the processing device 1 sets the service quality index for the second repair center to 0.9.

In step S706, the processing device 1 reads the repair center information to determine whether the repair center prioritizes a VIP repair request. If so, the calculation method proceeds to step S707; If not, the calculation method proceeds to step S708.

In step S707, the processing device 1 sets a very important person (VIP) matching score of the repair center as 1.

In step S708, the processing device 1 sets a VIP matching score of the repair center as 0.

In step S709, the processing device 1 calculates a customer preference index of the repair center based on the processing speed index, the processing speed weight, the service quality index, the service quality weight, the VIP matching score, and VIP matching weight of the repair center.

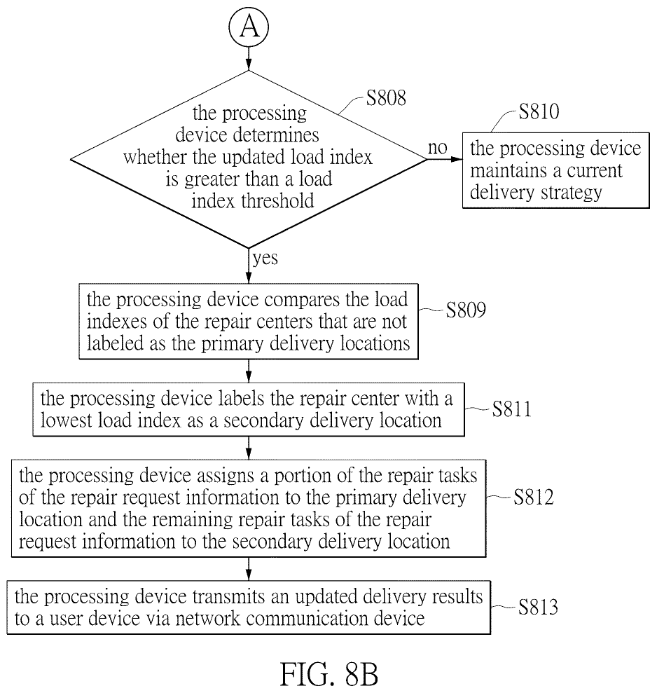

FIGS. 8A-8B is a flow chart of a repair management method according to a second embodiment of the present disclosure.

The repair management method of FIGS. 8A-8B includes steps S801 to S813, wherein steps S801 to S806 are similar to steps S201 to S206 of the FIG. 2, and the similarities between the two embodiments are not repeated here.

The repair management method of FIGS. 8A-8B differs from the repair management method of FIG. 2 in the following ways.

In step S807, the processing device 1 calculates an updated load index for a primary delivery location.

In step S808, the processing device 1 determines whether the updated load index is greater than a load index threshold. If so, step S809 is executed; If not, step S810 is executed.

In step S809, the processing device 1 compares the load indexes of the repair centers that are not labeled as the primary delivery locations.

In step S810, the processing device 1 maintains a current delivery strategy.

In step S811, the processing device 1 labels the repair center with a lowest load index as a secondary delivery location.

In step S812, the processing device 1 assigns a portion of the repair tasks of the repair request information K to the primary delivery location and the remaining repair tasks of the repair request information K to the secondary delivery location.

In step S813, the processing device 1 transmits an updated delivery results to a user device via network communication device 3.

Specifically, the repair request information includes multiple repair tasks. Since the primary delivery location is unable to handle all repair tasks independently, the processing device 1 allocates a part of all repair tasks to the primary delivery location and allocates the remaining repair tasks to the secondary delivery locations.

For example, the processing device labels the second repair center as the primary delivery location. Before considering the repair request information K, the quantity of tasks, the processing time, and the load index of the second repair center are 8, 30 hours, and 0.364, respectively. The repair request information K includes 10 repair tasks, and an estimated processing time for these 10 repair tasks is 300 hours. Therefore, after considering the repair request information K, the quantity of tasks of the second repair center is increased from 8 to 18, the processing hour of the second repair center is increased from 300 hours to 330 hours, and the load index of the second repair center is increased from 0.364 to 0.989.

Since the load index of the primary delivery location is greater than the load index threshold (e.g., 0.9), the processing device 1 selects one of the first, third, fourth, and the repair centers that are not labeled as the primary delivery location as the secondary delivery location.

The four load indexes of the first repair center, the third repair center, the fourth repair center, and the fifth repair center are 0.780, 0.743, 0.453, and 0.424 respectively. Since the load index of the fifth repair center is the lowest, the processing device 1 labels the fifth repair center as a secondary delivery location.

The processing device 1 assigns the repair tasks for eight laptops to the primary delivery location (e.g., the second repair center) and the remaining two laptops to the secondary delivery location (e.g., the fifth repair center). Based on this reassignment, the load index for the second repair center is 0.864, which does not exceed the load index threshold. The load index for the fifth repair center is 0.707, which does not exceed the load index threshold. Finally, the processing device 1 transmits information indicating that the second and fifth repair centers are respectively assigned as the primary delivery location and the secondary delivery location (i.e., the updated delivery result) to a user device via network communication device 3.

In addition, a non-transitory (non-volatile) computer-readable storage medium is disclosed, which is applied to a computing device or computer having a processor (e.g., a CPU, GPU, etc.) and/or a memory, and stores instructions. This computing device or computer can be used to execute the non-transitory computer-readable storage medium through the processor and/or memory to perform the above-mentioned method and each step when executing this non-transitory computer-readable storage medium.

### Beneficial Effects of the Embodiments

In conclusion, the repair management system, the repair management method, and the non-transitory computer-readable storage medium select an appropriate repair center as a primary delivery location according to the comprehensive weight index of each of the repair centers, thereby preventing repair centers from being overloaded or idle. The repair center information stored in each of the repair center hosts is appropriately utilized to improve repair service quality, repair service efficiency, and scheduling flexibility of each of the repair centers.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A repair management system, communicatively connected to a plurality of repair center hosts respectively located in a plurality of repair centers, and the repair management system comprising:
a processing device for receiving pieces of repair center information from the plurality of repair center hosts;
a storage device electrically connected to the processing device, wherein the storage device stores repair request information, and the processing device is configured to access the plurality of repair center hosts to perform:
calculating a repair center characteristic index set of each of the repair centers according to the pieces of repair center information and the repair request information;
calculating a comprehensive weight index of each of the repair centers according to the repair center characteristic index set of each of the repair centers; and
labelling the repair center corresponding to a largest one among the comprehensive weight indexes as a primary delivery location.

2. The repair management system according to claim 1, wherein the repair center characteristic index set includes a load index, a demand type index, a geographical location index, a priority index, and a customer preference index.

3. The repair management system according to claim 1, wherein the processing device is configured to calculate an updated load index of the primary delivery location, and the processing device is configured to determine whether the updated load index is greater than a load index threshold; when the updated load index is greater than the load index threshold, the processing device is configured to label one of the other repair centers that is not labeled as the primary delivery location as a secondary delivery location.

4. The repair management system according to claim 3, wherein the repair request information includes a plurality of repair tasks, and the processing device is configured to allocate a portion of the plurality of repair tasks to the primary delivery location and allocate a remaining portion of the plurality of repair tasks to the secondary delivery location.

5. The repair management system according to claim 2, wherein each of the pieces of repair center information includes a quantity of tasks, a maximum quantity of tasks, a processing time, a maximum processing time, a variability index, and a maximum variability index, and the processing device is configured to calculate the load index of each of the repair centers according to the quantity of tasks, the maximum quantity of tasks, the processing time, the maximum processing time, the variability index, and the maximum variability index.

6. The repair management system according to claim 5, wherein each of the pieces of repair center information includes a task diversity index, a technical complexity index and a brand diversity index, and the processing device is configured to calculate the variability index of each of the repair centers according to the task diversity index, the technical complexity index and the brand diversity index.

7. The repair management system according to claim 2, wherein the processing device reads a plurality of fault percentages of the repair request information and a plurality of repair matching scores of each of the pieces of repair center information, and calculates the demand type index of each of the repair centers according to the plurality of fault percentages and the plurality of repair matching scores.

8. The repair management system according to claim 2, wherein the repair request information includes a customer location, and each of the pieces of repair center information includes a repair center location, the processing device is configured to calculate the geographical location index of each of the repair centers according to the customer location and the repair center location.

9. The repair management system according to claim 2, wherein each of the pieces of repair center information includes a cooperative relationship index, a task importance index, and an expertise index, and the processing device is configured to calculate the priority index of each of the repair centers according to the cooperative relationship index, the task importance index, and the expertise index.

10. The repair management system according to claim 2, wherein each of the pieces of repair center information includes a processing speed index, a service quality index, and a very important person matching score, the processing device is configured to calculate the customer preference index of each of the repair centers according to the processing speed index, the service quality index, and the very important person matching score.

11. A repair management method comprising:
reading, by a processing device, repair request information of a storage device and pieces of repair center information of a plurality of repair centers;
calculating, by the processing device, a repair center characteristic index set of each of the repair centers according to the pieces of repair center information and the repair request information;
calculating, by the processing device, a comprehensive weight index of each of the repair centers according to the repair center characteristic index set of each of the repair centers; and
labelling, by the processing device, the repair center corresponding to a largest one among the comprehensive weight indexes as a primary delivery location.

12. The repair management method according to claim 11, wherein the repair center characteristic index set includes a load index, a demand type index, a geographical location index, a priority index, and a customer preference index.

13. The repair management method according to claim 11, further comprising: calculating an updated load index of the primary delivery location; determining whether the updated load index is greater than a load index threshold; and labelling one of the other repair centers that is not labeled as the primary delivery location as a secondary delivery location when the updated load index is greater than the load index threshold.

14. The repair management method according to claim 13, wherein the repair request information includes a plurality of repair tasks, and the processing device allocates a portion of the plurality of repair tasks to the primary delivery location and allocates a remaining portion of the plurality of repair tasks to the secondary delivery location.

15. The repair management method according to claim 12, wherein each of the pieces of repair center information includes a quantity of tasks, a maximum quantity of tasks, a processing time, a maximum processing time, a variability index, and a maximum variability index, and the processing device is configured to calculate the load index of each of the repair centers according to the quantity of tasks, the maximum quantity of tasks, the processing time, the maximum processing time, the variability index, and the maximum variability index.

16. The repair management method according to claim 15, wherein each of the pieces of repair center information includes a task diversity index, a technical complexity index and a brand diversity index, and the processing device calculates the variability index of each of the repair centers according to the task diversity index, the technical complexity index and the brand diversity index.

17. The repair management method according to claim 12, wherein the processing device reads a plurality of fault percentages of the repair request information and a plurality of repair matching scores of each of the pieces of repair center information, and calculates the demand type index of each of the repair centers according to the plurality of fault percentages and the plurality of repair matching scores.

18. The repair management method according to claim 12, wherein the repair request information includes a customer location, each of the pieces of repair center information includes a repair center location, and the processing device calculates the geographical location index of each of the repair centers according to the customer location and the repair center location.

19. The repair management method according to claim 12, wherein each of the pieces of repair center information includes a cooperative relationship index, a task importance index, and an expertise index, and the processing device calculates the priority index of each of the repair centers according to the cooperative relationship index, the task importance index, and the expertise index.

20. The repair management method according to claim 12, wherein each of the pieces of repair center information includes a processing speed index, a service quality index, and a very important person matching score, the processing device is configured to calculate the customer preference index of each of the repair centers according to the processing speed index, the service quality index, and the very important person matching score.

21. A non-transitory computer-readable storage medium, wherein the non-transitory computer-readable storage medium stores a plurality of instructions, and the plurality of instructions are executed by a processing device to generate the repair management method as claimed in claim 11.
